(19) United States
(12) Patent Application Publication
(10) Pub. No.: US 2015/0153854 A1
(43) Pub. Date: Jun. 4, 2015

(54) EXTENSION OF WEARABLE INFORMATION HANDLING DEVICE USER INTERFACE

(71) Applicant: Lenovo (Singapore) Pte. Ltd., Singapore (SG)

(72) Inventors: Aaron Michael Stewart, Raleigh, NC (US); Howard Locker, Cary, NC (US); John Weldon Nicholson, Cary, NC (US); Michaela Rose Case, Raleigh, NC (US)

(73) Assignee: Lenovo (Singapore) Pte. Ltd., Singapore (SG)

(21) Appl. No.: 14/094,839

(22) Filed: Dec. 3, 2013

(51) Int. Cl. G06F 3/041; G06F 3/0488; G06F 3/01

(52) U.S. Cl. CPC G06F 3/041; G06F 3/017; G06F 3/0414; G06F 3/0488

(57) ABSTRACT

An embodiment provides a wearable information handling device, including: a display device; a band operatively coupled to the display, the band including a band input component; a processor operatively coupled to the display; and a memory device accessible to the processor and storing code executable by the processor to: receive user input via the band input component; map the user input received via the band input component to a predetermined action; and execute the predetermined action according to the user input. Other aspects are described and claimed.

### BACKGROUND

The popular functionalities of information handling devices (“devices”), for example smart phones, tablets, e-readers, etc., are being converted into wearable formats. An example of such a wearable information handling device is a smart watch such as the Samsung GALAXY GEAR smart watch. GALAXY GEAR is a registered trademark of Samsung Electronics Co., Ltd. in the United States and/or other countries. Other examples of wearable information handling devices include bracelets, sleeves, gloves, and like articles that, while wearable by a user, provide electronic or computing functionality similar to smart phones and other mobile computing devices.

### BRIEF SUMMARY

In summary, one aspect provides a wearable information handling device, comprising: a display device; a band operatively coupled to the display, the band including a band input component; a processor operatively coupled to the display; and a memory device accessible to the processor and storing code executable by the processor to: receive user input via the band input component; map the user input received via the band input component to a predetermined action; and execute the predetermined action according to the user input.

Another aspect provides a method, comprising: receiving, at a band input component of a wearable information handling device, user input; mapping, using a processor of the wearable information handling device, the user input received via the band input component to a predetermined action; and executing, on an operatively coupled display device, the predetermined action according to the user input.

A further aspect provides a wearable information handling device, comprising: a display device; and a band operatively coupled to the display, the band including a band input component; the band receiving user input via the band input component; and the display executing a predetermined action according to the user input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2(A-B) illustrates example wearable devices with extended user interfaces.

FIG. 3 illustrates an example method of using a wearable device having an extended user interface.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well known structures, materials, or operations are not shown or described in detail to avoid obfuscation.

Wearable information handling devices (“devices” or “wearable devices”) such as smart watches, arm bands, bracelets, etc., are an upcoming form-factor in mobile computing. Wearable devices such as smart watches tend to rely on traditional methods of accepting input, e.g., touch screens and/or buttons provided near the display. However, often times the smaller format of the wearable device leads to a necessarily smaller display screen or device.

On mobile devices such as smartphones and tablets, there is generally enough space to touch content for manipulation and interaction. In the context of these form factors (tablets, phones, etc.), some users have already begun shifting to a tiny stylus input device because finger input obstructs too much of the display. However, using such solutions, especially in the context of a wearable device, tends to complicate the device inasmuch as it requires an additional peripheral or component, i.e., the stylus. Moreover, adding additional conventional controls (e.g., buttons) to the display area or watch body compound the complexity of the interface landscape, e.g., by cluttering the display area with buttons or other physical controls/protrusions, which often the user struggles to utilize or understand. Consequently, new user interfaces and associated input mechanisms would help to fulfill wearable devices' potential as always-on companion devices.

Accordingly, an embodiment extends the user interface of a wearable device to the peripheral parts. For example, an embodiment provides a wearable device, e.g., a smart watch, which accepts touch controls in a peripheral part, e.g., the watch band, instead of at the main display (e.g., the watch face containing the touch screen display). Thus, users may interface with the wearable device without needing to obstruct the already minimized display device with the input element (e.g., stylus, finger tip, etc.).

The illustrated example embodiments will be best understood by reference to the figures. The following description is intended only by way of example, and simply illustrates certain example embodiments.

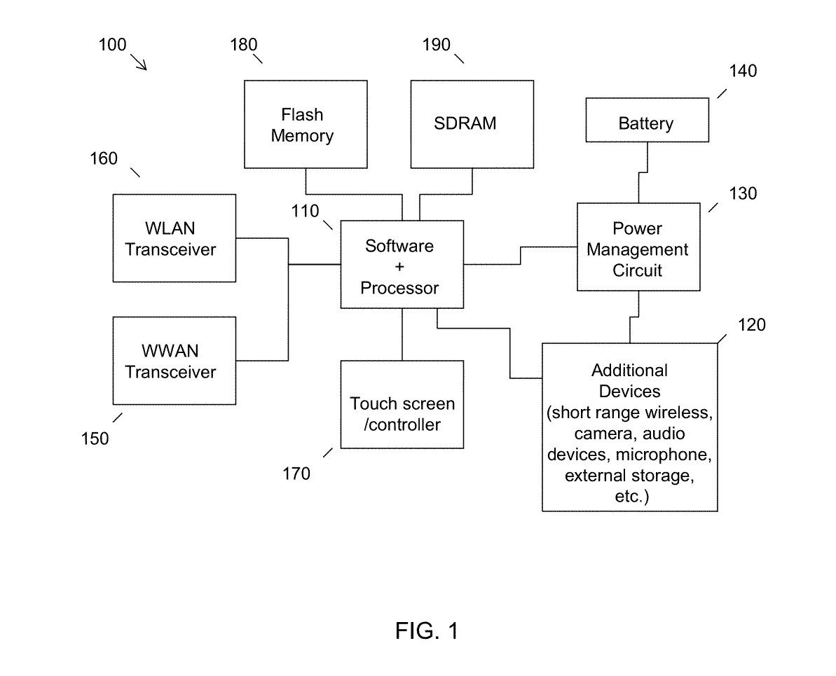

Referring to FIG. 1, while various other circuits, circuitry or components may be utilized in information handling devices, with regard to a wearable information handling device's circuitry, for example a smart watch or bracelet, an example illustrated in FIG. 1 includes a system on a chip design 100 found for example in tablet or other small, mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless base stations. Commonly, system 100 will include a touch screen 170 for data input and display. System 100 also typically includes various memory devices, for example flash memory 180 and SDRAM 190. As is apparent from the description herein, embodiments may include other features or only some of the features of the example illustrated in FIG. 1.

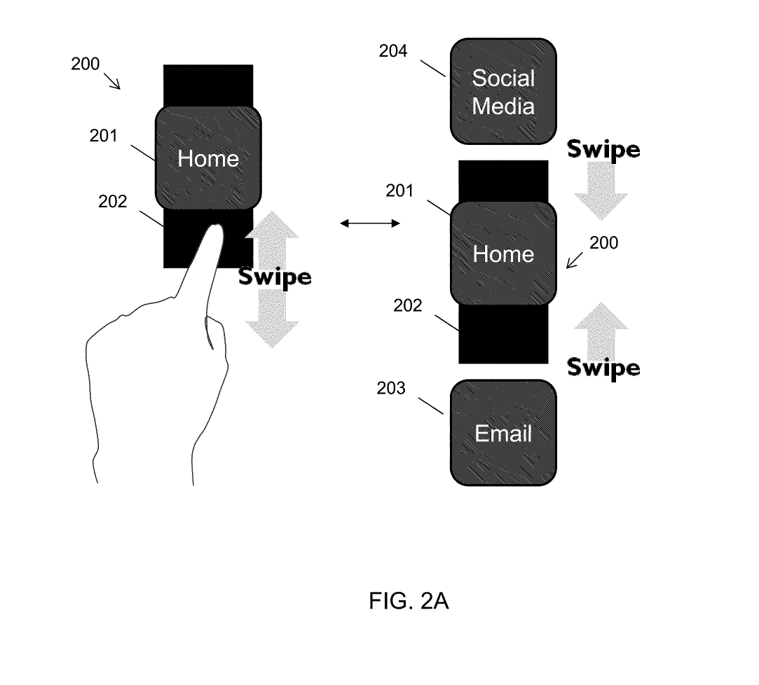

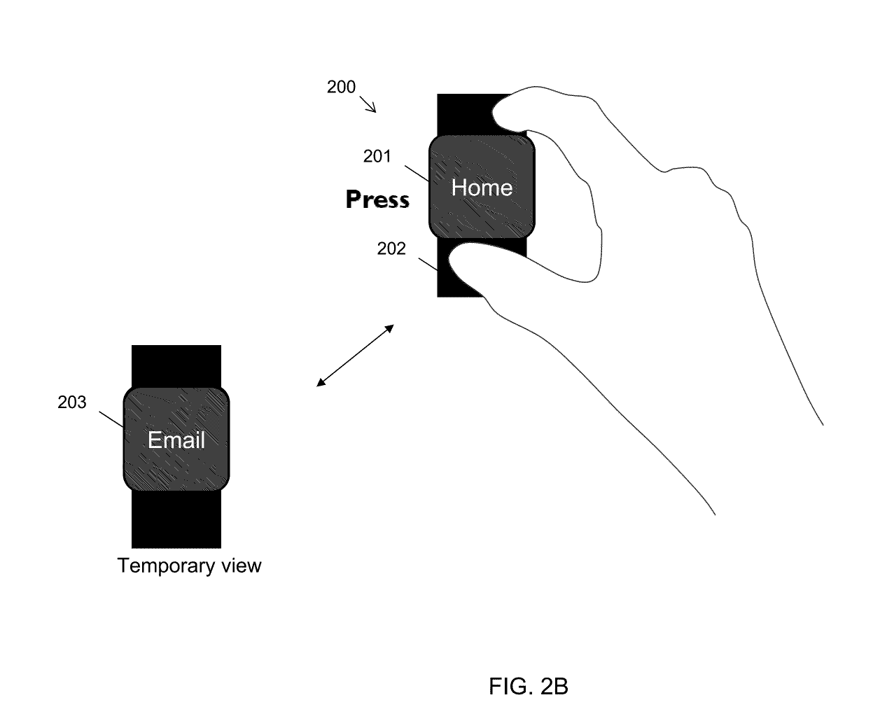

Information handling device circuitry and components, as for example outlined in FIG. 1, may be included in a wearable form factor such as a smart watch, examples of which are illustrated in FIG. 2(A-B).

In an embodiment, a wearable device 200 is provided with an extended user interface by including an input component in an area outside of the display area 201. In the example case of a smart watch wearable device 200, noting that this is a non-limiting example form factor, a user interface component (and/or associated controls) may be located in the band 202.

With a seamless integration into the bad 202, the user input for control of the wearable device may be supplied by the user without adding to the complexity or parts required to the device's display 201 or “body” (e.g., watch face) area. This tends to simplify user interaction with the wearable device from the user's perspective.

The input component(s) located in the band 202 may take a variety of forms depending, e.g., on the input type(s) desired, the control(s) to be implemented, and the technology available. For example, in addition to more conventional touch sensitive surfaces, e.g., capacitive touch sensitive surface for example found in a touch pad, the input component may include technologies such as flexible capacitive sensors or artificial (super skin′) developed by Stanford University to support common touch input, e.g., as one or multi-finger gestures. Alternatively or additionally, technology that senses indirect touch via motion sensors and/or muscle activity sensors (via electrical sensing) may be utilized. With some technologies it is also possible to support pressure based input sensing as well. Additionally or in the alternative, touch-less gesture inputs may be detected, e.g., using an optical sensor or sensors. Given the user input component located in a different area of the wearable device 200 (outside of the display 201), the wearable device may react to the user input in a number of ways.

For example, in FIG. 2A a device 200 is illustrated that has a default or home view, e.g., a display 201 having a rendering of the current time. The user may provide input to an input component located in the band 202, e.g., a swipe up or down on the band 202, to switch the home or default view from the current time to other views such as email, phone, calendar, social media feed, etc. Similarly, the band 202 and input component thereof may also be used to adjust various settings (e.g., application settings such as the current time, component settings such as audio amplitude, screen brightness, etc.) through swiping, dragging, flicking, and/or other gestures provided on or to the band 202.

Another example is illustrated in FIG. 2B. Here again, the wearable device 200 has a home or default view, e.g., the current time. The user may press and hold two fingers on the band 202, e.g., as sensed through a touch sensitive surface or a pressure sensitive surface, to change to another view, e.g., an email view rendered on the display 201. This change may persist only so long as the user continues to provide the given input to the band 202. For example, if the user releases or stops the input to the band 201, the view returns to the default or home view, e.g., of the current time.

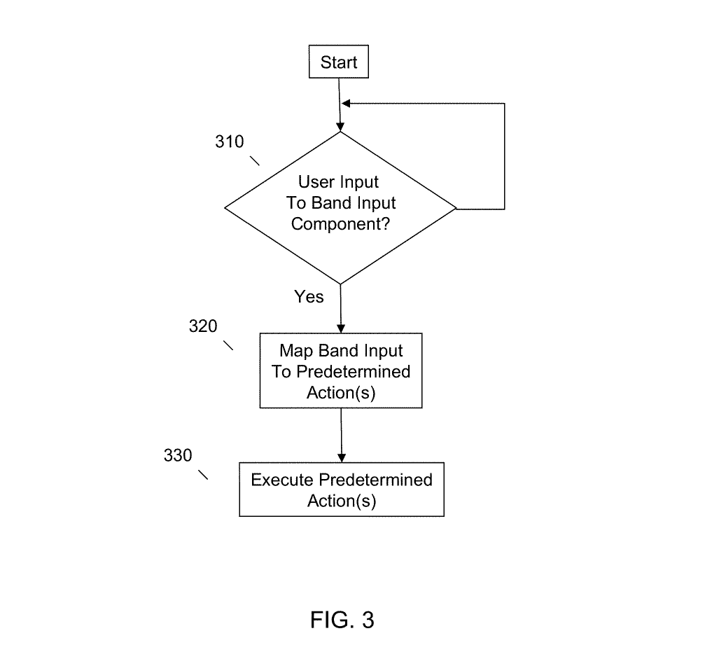

Turning to FIG. 3, it may be appreciated from the illustration that an embodiment senses user inputs provided to the extended interface at 310, e.g., band component or portion of a wearable device such as a smart watch. If there is user input sensed at 310, an embodiment may map the user input provided to the band input component to a predetermined action at 320. For example, an embodiment may map a given user input to a predetermined action such as switching application display(s), updating or changing settings, providing a temporary view of another application, etc. Thus, an embodiment may implement or execute predetermined action(s) based on the association or mapping between the user provided input(s) and the capabilities of the wearable device and its applications.

It will be understood that in certain embodiments various components and/or processing or other functionality may be distributed across devices. For example, processing (e.g., mapping) may take place on a device separate from the band, e.g., processing by a wirelessly connected phone, key fob, etc., that includes a processor that maps inputs received via the band. Likewise, a display may be operatively coupled to the band and/or other components, e.g., a component separately processing or mapping band inputs, for display of content affected by the user inputs to the band.

Although an embodiment may also provide a conventional touch screen or display, an embodiment also extends the user interface of wearable devices to the peripheral parts thereof. In the example of a smart watch, an embodiment provides an input component (or components) in a peripheral portion such as the band that accepts touch controls instead of or in addition to the main display. Thus, users may interface with the wearable device without needing to obstruct the already minimized display device. The integrated user input component(s), e.g., of the band portion (or similar peripheral portion) tends to de-clutter the body or display portion of the wearable device, providing a more intuitive user interface for control of the wearable device.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A wearable information handling device, comprising:
a display device;
a band operatively coupled to the display, the band including a band input component;
a processor operatively coupled to the display; and
a memory device accessible to the processor and storing code executable by the processor to:
receive user input via the band input component;
map the user input received via the band input component to a predetermined action; and
execute the predetermined action according to the user input.

2. The wearable information handling device of claim 1, wherein the band input component comprises a touch sensitive surface.

3. The wearable information handling device of claim 1, wherein the band input component comprises a pressure sensitive input component.

4. The wearable information handling device of claim 1, wherein the band input component comprises a gesture input component.

5. The wearable information handling device of claim 1, wherein the band input component includes a muscle activity sensing component.

6. The wearable information handling device of claim 1, wherein the predetermined action comprises changing a displayed application to a newly displayed application.

7. The wearable information handling device of claim 1, wherein the predetermined action comprises changing a current setting to a new setting.

8. The wearable information handling device of claim 7, wherein the current setting is an application setting.

9. The wearable information handling device of claim 1, wherein the band input component comprises a multi-touch input surface.

10. The wearable information handling device of claim 1, wherein to map comprises mapping user input to swiping input.

11. A method, comprising:
receiving, at a band input component of a wearable information handling device, user input;
mapping, using a processor of the wearable information handling device, the user input received via the band input component to a predetermined action; and
executing, on an operatively coupled display device, the predetermined action according to the user input.

12. The method of claim 11, wherein the band input component comprises a touch sensitive surface.

13. The method of claim 11, wherein the band input component comprises a pressure sensitive input component.

14. The method of claim 1, wherein the band input component comprises a gesture input component.

15. The method of claim 11, wherein the band input component includes a muscle activity sensing component.

16. The method of claim 11, wherein the predetermined action comprises changing a displayed application to a newly displayed application.

17. The method of claim 11, wherein the predetermined action comprises changing a current setting to a new setting.

18. The method of claim 17, wherein the current setting is an application setting.

19. The method of claim 11, wherein the band input component comprises a user input component selected from the group of input components consisting of a multi-touch input component, and a gesture input component.

20. A wearable information handling device, comprising:
a display device; and
a band operatively coupled to the display, the band including a band input component;
the band receiving user input via the band input component; and
the display executing a predetermined action according to the user input.
